(19) United States
(12) Patent Application Publication
(10) Pub. No.: US 2006/0050748 A1
(43) Pub. Date: Mar. 9, 2006

(54) Laser device

(75) Inventors: Tetsumi Sumiyoshi, Tokyo (JP); Jun Sakuma, Tokyo (JP)

Correspondence Address: PEARNE & GORDON LLP, 1801 EAST 9TH STREET, SUITE 1200, CLEVELAND, OH, 44114-3108, US

(73) Assignee: Cyber Laser, Inc., Tokyo (JP)

(21) Appl. No.: 11/219,062

(22) Filed: Sep. 2, 2005

(30) Foreign Application Priority Data
Sep. 6, 2004 (JP) 2004-259075

(51) Int. Cl. H01S 3/10; H01S 3/30

(52) U.S. Cl. 372/21; 372/6; 372/5

(57) ABSTRACT

A laser device that generates a CW laser beam in the ultraviolet range with a wavelength of less than 200 nm by inputting two laser beams having different wavelengths to a nonlinear optical crystal which is, for example, a CLBO crystal, to perform sum frequency mixing, and among the two laser beams, at least one laser beam is output from a fiber laser device. Thereby, the volume of the laser device portion of a processing device or a measuring device that uses an ultraviolet laser beam can be made small, and the effective use of workspace can be realized.

### BACKGROUND OF THE INVENTION

1. Field of the Invention

The present invention concerns a laser device that performs sum frequency mixing of two laser beams having different wavelengths, and emits a CW laser beam in the ultraviolet wavelength range.

Laser beams are used for important applications in processing, measurement, communication, and other fields, because of their high coherence. The shorter the wavelength of a laser beam, the more easily absorbed by materials, so the more advantageous for the processing of surface portions, for example ablation processing and the like. Additionally, since the photons have high energy, the photochemical effects are large, so that they are effective for cleaning, such as decomposition and removal of contaminants from semiconductor surfaces. Further, since their diffraction limit is low, their demand is growing in applications as lights sources for high resolution patterning, and as a processing means for opening holes in miniature circuit boards.

In particular, in recent years, the importance of ultraviolet lasers are recognized for the detection of foreign particles in clean rooms and the like which are an obstacle to the miniaturization of patterns associated with high integration of semiconductors, or in the laser measurement field of wafer surface examination of semiconductors and the like. Also, ultraviolet laser beams are used as an indispensable energy source in the matrix-assisted laser desorption/ionization method in, for example, protein mass spectroscopy. Further, short wavelength laser beams have become an indispensable processing means for the formation of tiny recording pits for the realization of high density recording.

Since short wavelength light is easily absorbed by substances, and can be focused to a tiny point, ultraviolet laser beams in particular are indispensable in the areas of biophotonics and nanotechnology, and cannot be replaced by anything else. In particular, at present, demand for mass spectroscopy, which may be used for the study of sugar chain structure, the analysis of trace elements in environmental studies and the like is growing, and the demand for ultraviolet laser beams is also growing accordingly.

Additionally, because ultraviolet laser beams have a short wavelength, they are an indispensable light source for miniaturized processing. Particularly, in manufacturing processes for semiconductors, ultraviolet light is an important light source for lithography. Normally, excimer lasers are used as lithography light sources, but a plurality of optical components are used in lithography devices, and a laser device that emits an ultraviolet laser beam with a short wavelength is needed for the detailed examination thereof. During the manufacturing process of semiconductor devices or micromachines, ultraviolet laser beams are used for processing, such as for the formation of contact holes. Since the diffraction limit of ultraviolet laser beams is small, the spot diameter can be made small. Additionally, since the photochemical effects against materials are large, the removal processing ability thereof is high.

2. Description of Related Art

As practical devices using ultraviolet laser beams are being developed, examples of their use for practical fields is increasing. However, the main bodies of laser devices that generate ultraviolet laser beams have generally become large, making their handling inconvenient. In conventional laser devices for generating ultraviolet laser beams, a laser beam with a pulsed fundamental wavelength (e.g., 1064 nm) using Nd:YAG lasers and the like is obtained, and this is input to a nonlinear optical crystal to generate an ultraviolet laser beam in the vicinity of 200 nm. Such an art has been published, for example, in Japanese Unexamined Patent Publication No. 2002-258339.

When using an ultraviolet laser beam, it is often the case that laser beams having a wavelength in a specific ultraviolet range are used. In order to generate a laser beam matching this specific wavelength, harmonic wavelength conversion and sum frequency mixing are used. For example, for generating a laser beam with wavelength 198.5 nm, a laser beam having a wavelength of 1064 nm and a laser beam having a wavelength of 244 nm are used. A laser beam emitted from a Nd:YAG laser device is used for the 1064 nm wavelength laser beam, while a laser beam emitted from a SH (second harmonic) argon ion laser device is used for the 244 nm wavelength laser beam. However, the laser oscillator for a Nd:YAG laser would, in the case of an approximately 10W output for example, require a very large volume, if the water cooling device for the amplification portion is included. For a constitution wherein an Nd:YAG laser device and an amplifier are connected in a two-stage cascade, the device would become even larger.

Additionally, for a SH argon ion laser device wherein a laser beam with a wavelength of 488 nm is emitted by an argon ion laser device, and then the output laser beam is input to a nonlinear optical crystal in order to obtain a second harmonic (SH), the laser head would become larger. In this case, even if the Nd:YAG laser that outputs a laser beam having a wavelength of 1064 nm could be miniaturized, the device on the whole would become larger. Therefore, a laser device that outputs an ultraviolet laser by performing sum frequency mixing using laser beams with the two wavelengths of 1064 nm and 244 nm would necessarily become large. This becomes a big obstacle during the use of processing devices or measurement devices utilizing ultraviolet laser beams.

### BRIEF SUMMARY OF THE INVENTION

The present invention realizes miniaturization and ease of use by constituting, using a fiber laser device, a laser device that generates a CW ultraviolet laser beam by applying sum frequency mixing and harmonic wavelength conversion to laser beams that have two different wavelengths. Since nonlinear phenomena are used for CW sum frequency mixing and harmonic wavelength conversion, the conversion efficiency is low. Accordingly, for at least one laser beam, a resonance type external resonator is used in order to increase the CW electric field. The efficiency improves because with this resonator, a longitudinal mode laser beam matched to the input wavelength is generated.

Therefore, the invention of the present application provides a laser device that performs sum frequency mixing by inputting at least two laser beams into a nonlinear optical crystal, and generating a CW laser beam with a wavelength of 200 nm or less, in order to solve the abovementioned problem. Of the at least two laser beams, one laser beam is a laser beam outputted from a fiber laser device. By using a fiber laser device, the ultraviolet laser beam generation device as a whole can be miniaturized.

In such a device constitution, the wavelength of the laser beam outputted from the fiber laser device is in the range of 1020 nm to 1100 nm. A laser beam with a wavelength in this range was generated using a relatively large solid state laser device using a conventional lasing crystal. By utilizing a fiber laser device as the light source of the laser beam that is to be used as the fundamental wave of the ultraviolet laser beam, it becomes possible to design a small device.

Additionally, the invention of the present application provides a device that generates one laser beam among the two laser beams that are used as fundamental waves for sum frequency mixing from a fiber laser device, and inputs the outputted laser beam into a nonlinear optical crystal. Thereby, it becomes possible to further miniaturize the total volume of the ultraviolet laser beam generation device. Additionally, when generating both of the two laser beams to be used as the fundamental waves for sum frequency mixing from the fiber laser device, the wavelength of one laser beam is in the range of 1020 nm to 1100 nm, while the wavelength of the other laser beam is in the range of 950 nm to 990 nm, or 1500 nm to 1580 nm. By doing so, the laser beams with two wavelengths used for the sum frequency mixing can be introduced from the fiber laser device. Further, a QPM element (quasi-phase matching element) is used as a first-step wavelength conversion element, placed in front of the light path whereby the laser beam is introduced into the nonlinear optical crystal. As QPM elements, periodically poled lithium niobate and lithium tantalite, PPLN, PPLT, and the like are used. Using a QPM element, wavelength conversion for obtaining laser beams for sum frequency mixing is performed, and the laser beam that is emitted by the QPM element is further inputted into a nonlinear optical crystal within a resonance type external resonator.

Additionally, in the laser device according to the invention of the present application the laser beam obtained from a fiber laser device is a laser beam with a single wavelength. In order to realize the wavelength conversion of this single wavelength laser beam, a resonance type external resonator is used. Additionally, in order to realize a second-step wavelength conversion, a constitution using a further resonance type external resonator is possible. For an input of a single wavelength laser beam, by matching the length of the light path of a ring type external resonator to an integer multiple of the wavelength of said laser beam, light with a strong electric field is formed in the resonator. If a nonlinear optical crystal is placed in a resonator in such a state, the strong electric field acts upon the nonlinear optical crystal, and an efficient nonlinear phenomenon can be created. The nonlinear optical crystal used for sum frequency mixing is placed inside an external resonator comprising a plurality of mirrors.

### BRIEF DESCRIPTION OF THE DRAWINGS

FIG. 1 is a diagram showing the constitution of the laser device according to embodiment 1 of the present invention.

FIG. 2 is a diagram showing one portion of the constitution of the laser device according to embodiment 2 of the present invention.

FIG. 3 is a diagram showing one portion of the constitution of the laser device according to embodiment 2 of the present invention.

### DETAILED DESCRIPTION OF THE INVENTION

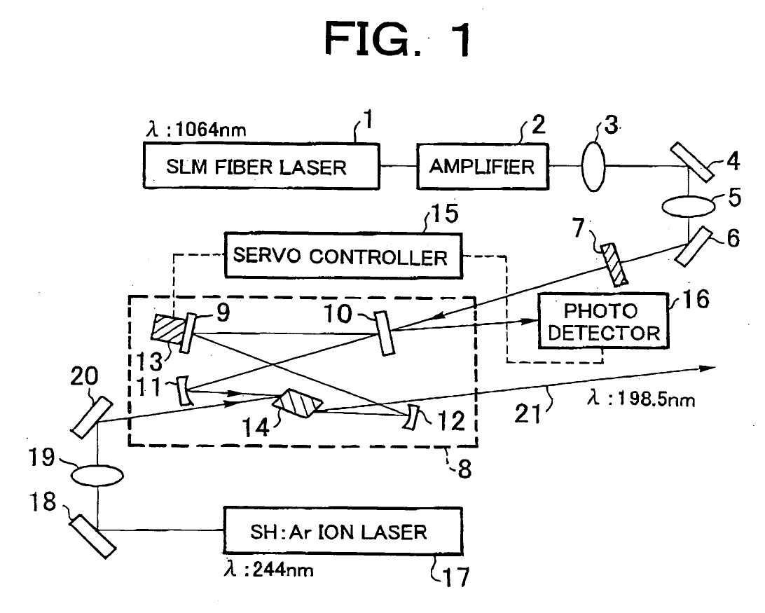

Herebelow, the invention of the present application shall be explained in detail, referring to the drawings. FIG. 1 is a diagram showing a constitution of the laser device according to embodiment 1 of the present invention. This laser device generates an ultraviolet laser beam by performing sum frequency mixing. In FIG. 1, 1 is a single longitudinal mode (SLM) fiber laser device that outputs a SLM fiber laser beam with a wavelength of 1064 nm, 2 is an amplifier that amplifies the laser beam outputted from the fiber laser device 1, 3 is a lens, 4 is a mirror, 5 is a lens, 6 is a mirror, 7 is a half-wave plate, and 8 is a ring type resonator. In the ring type resonator 8, 9, 10, 11, and 12 are mirrors, 13 is a driving element for adjusting the location or orientation of mirror 9, and 14 is a nonlinear optical crystal. Additionally, 15 is a servo controller controlling the driving element 14, and 16 is an photo detector that detects a laser beam that is partially transmitted by the mirror 10 and sends a detection signal to the servo controller 15. Additionally, 17 is a SH argon ion laser device that performs harmonic wavelength conversion and outputs a 244 nm wavelength laser beam, 18 is a mirror, 19 is a lens, and 20 is a mirror. Further, 21 is an ultraviolet laser beam with a wavelength of 198.5 nm that is output from the resonator 8.

A laser beam outputted from a SLM fiber laser device 1, after being amplified by an amplifier 2, passes through an optical system comprising a lens 3, a mirror 4, a lens 5, a mirror 6, and a half-wave plate 7, and is guided into a ring type resonator 8. A laser beam that is output from a SH argon ion laser device 17 passes through an optical system comprising a mirror 18, a lens 19, and a mirror 20, and is guided into a ring type resonator 8. By making a 1064 nm wavelength laser beam outputted from the SLM fiber laser device 1 and a 244 nm wavelength laser beam outputted from the SH argon ion laser device 17 enter a nonlinear optical crystal 14 that is a CLBO crystal (or a BBO crystal) to perform sum frequency mixing, an ultraviolet laser beam with a wavelength of 198.5 nm is generated.

The fiber laser device can be constituted to be smaller relative to a laser device using an ion laser device or a laser crystal. Therefore, the laser device that outputs the laser beam that is to be one of the fundamental waves in sum frequency mixing can be housed in a small body. Thus, by constituting the resonator 8 and the SH argon ion laser device 17 integrally within the processing device or measurement device, the miniaturization of the device as a whole can be realized. Additionally, the laser device according to this embodiment has a constitution wherein the fiber laser device 1 is used to guide a laser beam into the resonance type resonator 8, but the resonator 8 is not restricted to a resonance type resonator. The laser device according to this embodiment may have a constitution using a different type of resonator. For CW wavelength conversion, a high conversion efficiency can be obtained when a resonance type resonator is used.

The driving element 13 attached to the mirror 9 inside the resonator 8 is controlled by the servo controller 15. By operating the driving element 13, the phase of the laser beam that cycles inside the resonator 8 can be adjusted. Thereby, the length of the light path inside the ring type resonator 8 is matched to the wavelength of the laser beam outputted by the SLM fiber laser device 1, and the strength of the electric field inside the resonator 8 can be strengthened roughly 100 times. A CLBO crystal 14, which is a nonlinear optical crystal, is placed in the path of the one laser beam that is strengthened by resonance. The other laser beam that is output from the SH argon ion laser device 17 enters this CLBO crystal 14. Thereby, sum frequency mixing is performed with a high conversion efficiency, and an ultraviolet laser beam 21 with a wavelength of 198.5 nm is generated.

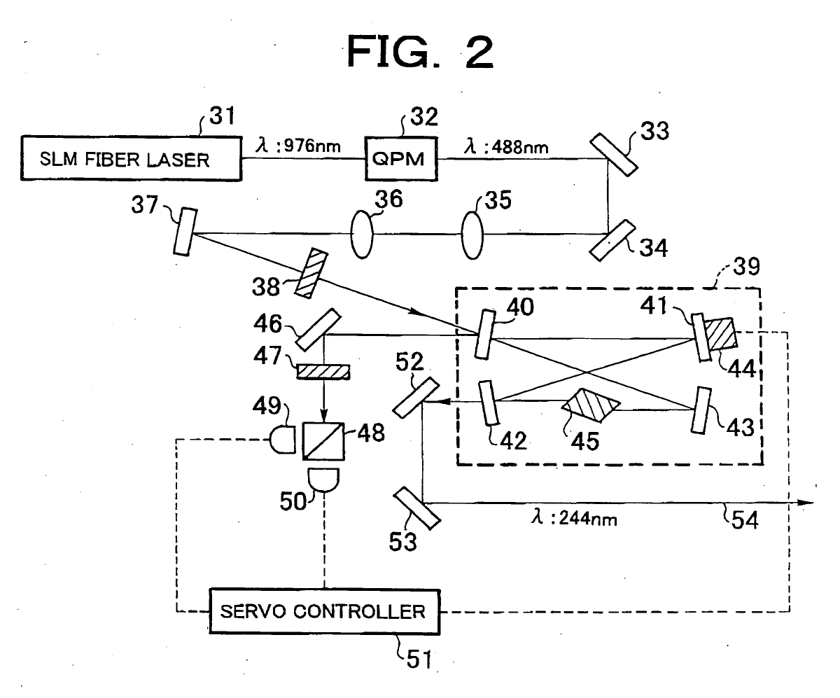

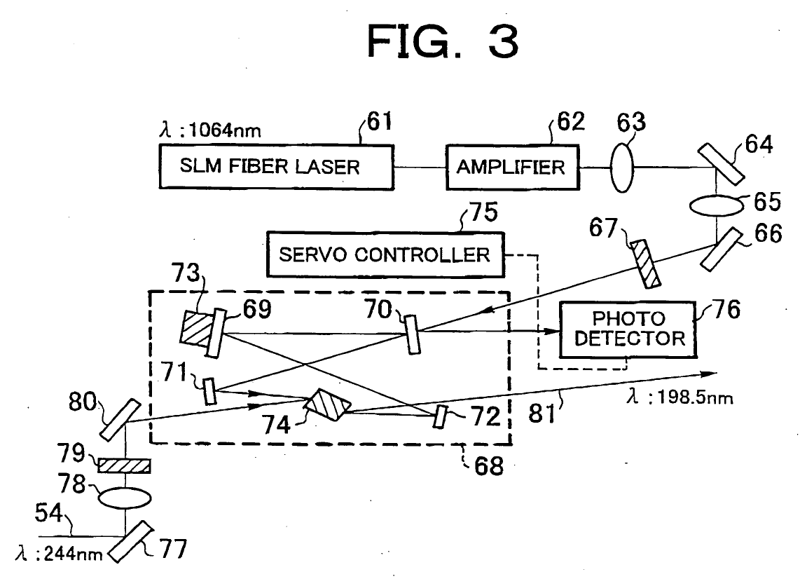

Next, the second embodiment of the present invention shall be explained with reference to FIG. 2 and FIG. 3. FIG. 2 and FIG. 3 are respectively diagrams that show a portion of the constitution of the laser device according to the second embodiment of the present invention. FIG. 2 shows a laser device that generates one of the fundamental wave laser beams that are sum frequency mixed. FIG. 3 shows a laser device that generates an ultraviolet laser beam by sum frequency mixing. The laser device according to the second embodiment of the invention of the present application is constructed by combining the laser device indicated by FIG. 2 and the laser device indicated by FIG. 3. In FIG. 2, 31 is a fiber laser device that outputs a single longitudinal mode (SLM) fiber laser beam with a wavelength of 976 nm, 32 is a QPM element that converts a wavelength of a laser beam that is output from the SLM fiber laser device 31, 33 and 34 are mirrors, 35 and 36 are lenses, 37 is a mirror, 38 is a half wave plate, and 39 is a ring type resonator. In the ring type resonator 39, 40, 41, 42, and 43 are mirrors, 44 is a driving element that controls the location or orientation of a mirror 41, and 45 is a nonlinear optical crystal. Additionally, 46 is a mirror, 47 is a quarter wave plate, 48 is a polarization beamsplitter, 49 and 50 are photo detectors, and 51 is a servo controller that inputs a detection signal from the photo detectors 49 and 50 and outputs a control signal to the driving element 44. Additionally, 52 and 53 are mirrors, and 54 is a laser beam with a wavelength of 244 nm that is output from the resonator 39.

A 976 nm wavelength laser beam outputted from the SLM fiber laser device 31 is wavelength converted in QPM element 32 to a 488 nm wavelength laser beam which is its second harmonic, then passes through an optical system comprising mirrors 33 and 34, lenses 35 and 36, a mirror 37, and a half wave plate 38, and is guided into a ring type resonator 39. The resonator 39 comprising mirrors 40, 41, 42, and 43, and a nonlinear optical crystal 45 that is a CLBO crystal (or a BBO crystal), outputs a 244 nm wavelength laser beam that is the second harmonic of the 488 nm wavelength laser beam. Thereby, the 976 nm wavelength laser beam outputted from the SLM fiber laser device 31 is wavelength converted, generating a 244 nm wavelength laser beam that is one of the laser beams whereon sum frequency mixing is to be done.

QPM element 32 has a nonlinear optical constant which is much greater than that for a single CLBO crystal or a BBO crystal, and since a sufficient second harmonic output can be obtained in a single pass, it becomes possible to simplify the constitution. The constitution of this embodiment is such that a 976 nm wavelength laser beam outputted from a SLM fiber laser device 31 is wavelength converted to a 488 nm laser beam that is its second harmonic. Further, in order to obtain a short wavelength laser beam, the laser beam outputted from the QPM element 32 is input to a nonlinear optical crystal 45. If a QPM element 32, which has a low conversion efficiency, is utilized in order to obtain a 244 nm laser beam that is the fourth harmonic of the 976 nm wavelength fundamental wave laser beam, the SHG output of the laser beam that is output from the SLM fiber laser device 31, that is, the output from the QPM element 32, will not be a laser beam with sufficient power. Therefore, in the second step wavelength conversion, an external resonator having a CLBO crystal (or a BBO crystal) that can perform wavelength conversion at high efficiency is used. By performing wavelength conversion using an electric field strengthening effect due to a nonlinear optical crystal 45 inside the resonator 39, a laser beam having a high output can be obtained.

A portion of the laser beam that enters in the resonator 39 and which is linearly polarized in a direction within the plane of the resonator 39, passes through the mirror 40, and exits the resonator 39. The laser beam that exits the resonator 39 obtains a perpendicular component of polarization by passing through the quarter wave plate 47. The polarization beamsplitter 48 splits the input laser beam into two laser beams having mutually perpendicular directions of polarization. The photo detectors 49 and 50 respectively detect laser beams having mutually perpendicular directions of polarization, and transmit detection signals to the servo controller 51. The servo controller 51 judges the state of the laser beam inside the resonator 39 based upon the ratio of the output signal from the photo detector 49 and the output signal from the photo detector 50, and in order to maintain optimal resonance conditions, outputs a control signal to a driving element 44 which is, for example, a piezo driving element. Thereby, the position or orientation of the mirror 41 is changed, and this adjustment is done automatically so as to match the length of the light path within the resonator 39 to the wavelength of the incoming laser beam, so that the electric field strength of the incoming laser beam is strengthened roughly 100 rimes. As described above, since the electric field strength of the laser beam incident on the resonator 39 is strengthened by realizing optical resonance conditions, harmonic conversion can be performed for the second harmonic laser beam outputted from the QPM element 32 at a relatively high conversion efficiency, and a 244 nm wavelength laser beam with a high output can be obtained.

Next, in FIG. 3, 61 is a fiber laser device that outputs a 1064 nm wavelength single longitudinal mode (SLM) fiber laser beam, 62 is an amplifier that amplifies the laser beam outputted from the fiber laser device 61, 63 is a lens, 64 is a mirror, 65 is a lens, 66 is a mirror, 67 is a half wave plate, and 68 is a ring type resonator. In the ring type resonator 68, 69, 70, 71, and 72 are mirrors, 73 is a driving element that adjusts the position or orientation of the mirror 69, and 74 is a nonlinear optical crystal. Additionally, 75 is a servo controller that controls the driving element 73, and 76 is an photo detector that detects a laser beam and transmits a detection signal to the servo controller 75. Additionally, 77 is a mirror that reflects a 244 nm wavelength laser beam 54 that is output from the laser device shown in FIG. 2, 78 is a lens, 79 is a half wave plate, and 80 is a mirror. Further, 81 is a 198.5 nm wavelength ultraviolet laser beam outputted from the resonator 68.

A laser beam that is output from an SLM fiber laser device 61 is amplified by an amplifier 62, then passes through an optical system comprising a lens 63, a mirror 64, a lens 65, a mirror 66, and a half wave plate 67, and is guided into a ring type resonator 68. A laser beam that is output from the laser device shown in FIG. 2 passes through an optical system comprising a mirror 77, a lens 78, a half wave plate 79, and a mirror 80, and is guided into a resonator 68.

The photo detector 76 can be realized by having a similar structure to the photo detection means comprising a quarter wave plate 47, a polarization beamsplitter 48, photo detectors 49 and 50, and the like, shown in FIG. 2. The photo detector 76 detects a laser beam that is partially transmitted by a mirror 70, and sends a detection signal to the servo controller 75. The servo controller 75 judges the state of the laser beam within the resonator 68 based upon the detection signal from the photo detector 76, and outputs a control signal to the driving element 73 in order to maintain optimal resonance conditions. Thereby, the position or orientation of the mirror 69 is changed, and the adjustment is done automatically so as to match the length of the light path within the resonator 68 to the wavelength of the incoming laser beam, so that optimal resonance conditions are satisfied. As a result, a strong electric field is formed within the nonlinear optical crystal, and the nonlinear effect is increased. A 1064 nm wavelength laser beam that is output by the SLM fiber laser device 61 and which has an increased electric field due to the resonance phenomenon, and a 244 nm wavelength laser beam outputted from the laser device shown in FIG. 2, are inputted to the nonlinear optical crystal 74 that is a CLBO crystal or a BBO crystal, and by performing sum frequency mixing, a 198.5 nm wavelength ultraviolet laser beam 81 is generated.

In this embodiment, the 1064 nm wavelength laser beam and the 976 nm wavelength laser beam, which are the fundamental wave laser beams for sum frequency mixing for obtaining an ultraviolet laser beam, are both laser beams in a wavelength band for which transmission can be done with low loss over great distances via quartz optical fibers. Therefore, by using a fiber laser device, portions of the laser device which comprise a large volume of the device can be placed in a place remote from the processing device or the measuring device that uses the ultraviolet laser beam. In the vicinity of the processing device or the measuring device, a wavelength conversion system that performs sum frequency mixing is placed. Generally, in the ultraviolet range, loss due to transmission of the laser beam over optical fibers is great, so the practical use of a fiber laser device that outputs an ultraviolet laser beam was difficult. The abovementioned 1064 nm wavelength laser beam and the 976 nm wavelength laser beam used for sum frequency mixing are within the wavelength band of near ultraviolet to infrared. In this wavelength band, the loss due to transmission over optical fibers is relatively small. Additionally, since the constitution is such that conversion to a short wavelength laser beam is done in the vicinity of processing devices or measuring devices over a plurality of steps, the decrease in transmission efficiency can be suppressed. In this way, the volumes of the portions of the laser devices that are placed in the vicinity of processing devices or measuring devices using ultraviolet laser beams can be made small, so the effective use of workspace can be realized.

In the abovementioned embodiment, laser beams having wavelengths of 1064 nm, 976 nm, 244 nm, and the like are used, but the laser beams that may be used for the invention of the present application are not restricted to these wavelengths. The laser device of the invention of the present application may use laser beams with wavelengths within the ranges of 1500 nm-1580 nm, 1020 nm-1100 nm, and 950 nm-990 nm.

Additionally, in the abovementioned embodiment, the laser beams that were incident on the ring resonators 8, 39, and 68 and cycle within the ring resonators were explained to be single longitudinal mode (SLM) laser beams. The invention of the present application may also use longitudinal multimode laser beams. In this case, the resonance type external resonator is designed so that the intermodal spacing of the resonator matches the intermodal spacing of the plurality of longitudinal modes of the incident light. Thereby, electric field within the resonator is strengthened, and it becomes possible to avoid a decrease in conversion efficiency.

1. A laser device characterized by being a laser device that generates a CW laser beam in the ultraviolet wavelength range by inputting two laser beams having different wavelengths to a nonlinear optical crystal to perform sum frequency mixing, wherein at least one of the laser beams among the two laser beams is outputted from a fiber laser device.

2. A laser device recited in claim 1, characterized in that the oscillation wavelength of the laser beam outputted from the fiber laser device is in the range of 1020 nm to 1100 nm.

3. A laser device recited in claim 2, wherein the laser beam outputted from the fiber laser device is a laser beam with a single frequency.

4. A laser device recited in claim 1, characterized in that the nonlinear optical crystal for sum frequency mixing is located within an external resonator comprising a plurality of mirrors, and the laser beam outputted from the fiber laser device is resonated by the external resonator.

5. A laser device recited in claim 1, characterized in that the two laser beams are respectively outputted from different fiber laser devices, the wavelength of the laser beam outputted from one fiber laser device being in the range of 1020 nm to 1100 nm, and the wavelength of the laser beam outputted from the other fiber laser device being in the range of 950 nm to 990 nm or 1500 nm to 1580 nm.

6. A laser device recited in claim 1, characterized in that among the two laser beams on which sum frequency mixing is done, at least one of the laser beams is a harmonic of a laser beam.

7. A laser device recited in claim 6, characterized in that a QPM element is used as a harmonic generation means.

8. A laser device recited in claim 6, characterized in that an external resonator is used as a harmonic generation means.

9. A laser device recited in claim 1, characterized in that the nonlinear optical crystal for sum frequency mixing is a BBO crystal.

10. A laser device recited in claim 1, characterized in that the nonlinear optical crystal for sum frequency mixing is a CLBO crystal.

11. A laser device recited in claim 1, characterized in that the laser beam outputted from the fiber laser device is a laser beam having multiple longitudinal modes, and the intermodal spacing of the external resonator for wavelength conversion is matched to the intermodal spacing of the longitudinal modes of the laser beam that is outputted from the fiber laser device.

12. A laser device recited in claim 1, characterized in that the laser beam outputted from the fiber laser device is a laser beam having multiple longitudinal modes, and the laser beam outputted from the fiber laser device is amplified by an amplifier, and the intermodal spacing of the external resonator for wavelength conversion is matched to the intermodal spacing of the longitudinal modes of the amplified laser beam.

13. A laser device recited in claim 1, characterized in that the laser beam outputted from the fiber laser device, or a laser beam obtained by amplifying the laser beam outputted from the fiber laser device with an amplifier, is guided into a QPM element to perform wavelength conversion.

14. A laser device characterized by being a laser device that generates a CW laser beam in the ultraviolet wavelength range by inputting two laser beams having different wavelengths to a nonlinear optical crystal to perform sum frequency mixing, wherein the ultraviolet laser beam is generated by inputting, to the nonlinear optical crystal laser, beams transmitted through optical fibers from a laser source located remotely from the place where the ultraviolet laser beam is used.
